(19) United States
(12) Patent Application Publication
(10) Pub. No.: US 2019/0138994 A1
(43) Pub. Date: May 9, 2019

(54) SYSTEM AND METHOD FOR IMPLEMENTING AN INTEGRATED B2B DIGITAL MOBILE CUSTOMER EXPERIENCE

(71) Applicants: KRISHAN DEEGALLA, SYDNEY (AU); GIRI RAMACHANDRAN, SYDNEY (AU)

(72) Inventors: KRISHAN DEEGALLA, SYDNEY (AU); GIRI RAMACHANDRAN, SYDNEY (AU)

(21) Appl. No.: 15/990,908

(22) Filed: May 29, 2018

Related U.S. Application Data
(60) Provisional application No. 62/563,642, filed on Sep. 27, 2017.

(51) Int. Cl. G06Q 10/10

(52) U.S. Cl. CPC G06Q 10/103; H04W 88/02

(57) ABSTRACT

In one aspect, a computerized method useful for implementing an integrated B2B digital mobile customer experience includes the step of, at a mobile device ordering stage, triggering a mobile device enrollment for a mobile device owned by a customer enterprise. The method includes the step of managing a set of application programming interface (API) micro services that enables a continuous integration of mobile device services for the mobile device. The method includes the step of setting up a mobile device profile-based ordering system that enables a mobile-device service provider to: add a custom catalog of mobile-devices service products for the customer enterprise. An administrator within the customer enterprise is enabled to define a product eligibility for the mobile device.

### CLAIM OF PRIORITY

This application claims priority from U.S. Provisional Application No. 62/563,642, SYSTEM AND METHOD FOR IMPLEMENTING AN INTEGRATED B2B DIGITAL MOBILE CUSTOMER EXPERIENCE and filed 27 Sep. 2017. This application is hereby incorporated by reference in its entirety for all purposes.

### BACKGROUND

Enterprise Mobility and Internet of Things (IoT) revolution has now well and truly commenced, with advancements in data capture, cloud, analytics, applications, network connectivity and offers tremendous operational efficiency and customer experience improvement opportunities for businesses.

However enterprises require end to end digital management capabilities to orchestrate and effectively life cycle manage mobility and IOT deployments to fully realize the potential benefits. Otherwise, these advancements can create more problems than it solves.

For Mobile Carriers and managed service providers providing such digital managed services capability to their B2B customers will help them differentiate their core offerings and position for new revenue streams. However, currently, digital delivery for business markets is either non-existent or caught up in overall consumer centric programs that are slow and stodgy. The needs, wants, decision making style, preferred channel models for business customers are very different for each enterprise consumer and require a specific digital delivery with deep understanding of the segment mastering. Implementing a B2B centric delivery model recognizing the complexity of B2B mobile domain is not easy. The current traditional systems integrator model of months and months of requirement gathering, design, and development are at best very time consuming and at worst outright wasteful of capital and resources. Accordingly, improvements that integrate a B2B digital mobile customer experience are required.

### BRIEF SUMMARY OF THE INVENTION

In one aspect, a computerized method useful for implementing an integrated B2B digital mobile customer experience includes the step of, at a mobile device ordering stage, triggering a mobile device enrollment for a mobile device owned by a customer enterprise. The method includes the step of managing a set of application programming interface (API) micro services that enables a continuous integration of mobile device services for the mobile device. The method includes the step of setting up a mobile device profile-based ordering system that enables a mobile-device service provider to: add a custom catalog of mobile-devices service products for the customer enterprise. An administrator within the customer enterprise is enabled to define a product eligibility for the mobile device. The method includes the step of generating a set of administrative workflows that provide an approval of the mobile-devices service product before an order for the mobile-devices service product is released by the enterprise to the service provider.

### BRIEF DESCRIPTION OF THE DRAWINGS

FIG. 1 illustrates an example system for implementing an integrated B2B digital mobile customer experience, according to some embodiments.

FIG. 2 depicts an exemplary computing system that can be configured to perform any one of the processes provided herein.

FIG. 3 is a block diagram of a sample computing environment that can be utilized to implement various embodiments.

FIG. 4 illustrates an example Enterprise mobile managed services platform ((EMMSP) for implementing an integrated B2B digital mobile customer experience, according to some embodiments.

FIG. 5 illustrates an example process for providing a single integrated experience B2B digital mobile customer, according to some embodiments.

FIG. 6 illustrates an example process for implementing an ordering module, according to some embodiments.

FIG. 7 illustrates another example system for implementing an integrated B2B digital mobile customer experience, according to some embodiments.

FIG. 8 illustrates an example services platform, according to some embodiments.

The Figures described above are a representative set, and are not an exhaustive with respect to embodying the invention.

### DESCRIPTION

Disclosed are a system, method, and article of manufacture for an integrated B2B digital mobile customer experience. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment of the present invention. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described In detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Application programming interface (API) can specify how software components of various systems interact with each other.

Business-to-business (B2B) refers to a situation where one business makes a commercial transaction with another business.

Internet of Things (IoT) refers to the inter-networking of physical devices, vehicles, buildings, and/or other items embedded with electronics, software, sensors, actuators, and/or network connectivity which enable these objects to collect and exchange data.

Mobile devices can refer to a computing device small enough to hold and operate in the hand such as smartphones, tablet computers, etc.

Mobile device management (MDM) mobile device management (MDM) is a type of security software used by an IT department to monitor, manage and secure employees' mobile devices that are deployed across multiple mobile service providers and across multiple mobile operating systems being used in the organization.

Enterprise mobile managed services platform (EMMSP) is an end to end system for managing delivery and life cycle management of enterprise mobile services, including IOT. This includes ordering, enrolment, security, management and support.

Telecommunications service provider (TSP) is a type of communications service provider that has traditionally provided telephone and similar services. This category includes incumbent local exchange carriers, competitive local exchange carriers, and mobile wireless communication companies

Example Systems

Enterprises need to supplement their vertical mobility IT investments with effective horizontal digital managed services platform capabilities. These comprehensive end to end management capabilities combine:

Self-service capability providing flexibility for the end users within enterprise to complete common tasks quickly and easily. Comprehensive Management capability for the administrators to support, govern and life cycle manage portfolio of deployments including connecting to external support partners where necessary

Enterprise mobility & IOT digital Managed services platform will address key enterprise life cycle management components such as ordering, multi-supplier delivery orchestration, BYOD, provisioning, on boarding, security, audits, reporting, asset management and support. Enterprise mobility & IOT managed service platform will integrate with multiple vendors, variety of solutions internal and external systems to provide a comprehensive end to end experience for customers.

This digital managed service platform capability will be completely complimentary to any vertical application strategy pursued by the enterprise and act as the common foundation for scalable, reliable delivery.

Enterprises can deploy these digital managed services themselves or through mobile carriers/managed service providers who offer this as a value add to their core services.

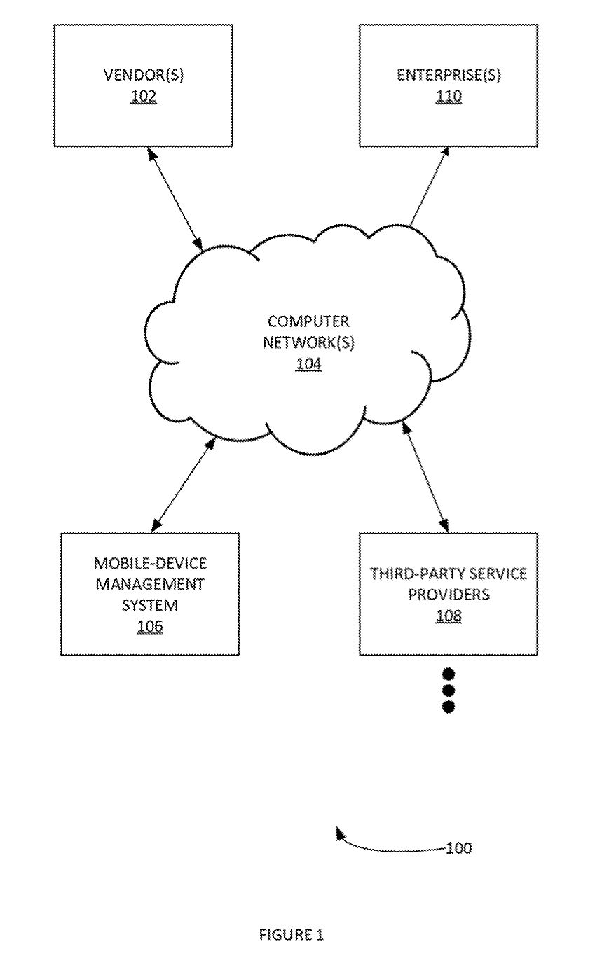

FIG. 1 illustrates an example system 100 for implementing an integrated B2B digital mobile customer experience, according to some embodiments. System 100 can include various process, such processes such as 500 and 600 infra. System 100 can implement systems 200, 300 and/or 400 infra.

The entities of system 100 can be server systems and/or other computer-implemented functionalities. These entities can communicate via computer network(s) 104. Computer network(s) 104 can include, inter alia: the Internet, enterprise private networks, local area networks, cellular networks, etc.

Vendors 102 can be entities that sell/lease mobile devices. Venders 102 can include, inter alia: mobile device vendors (e.g. Google®, Apple®, Samsung®, etc.), IoT services and/or hardware providers, other hardware system providers, etc.

Enterprise mobile managed services platform (EMMSP) 106 can implement a B2B digital mobile customer experience including, inter alia: EMMSP, ordering, enrolment, security, management and support as a single integrated experience. Enterprise and service providers utilized the B2B digital mobile customer experience (e.g. rather than “swivel chairing” by logging into inputting in multiple systems) to create an improved experience and increased compliance with enterprise security and business policies. Enterprise mobile managed services platform (EMMSP) 106 can provide access to other entities of system 100 via a dashboard. Mobile-device management system 106 can implement Enterprise mobile managed services platform (EMMSP) 400 provided infra.

Enterprise(s) 110 can include various entities (e.g. businesses, governmental entities, non-profit entities, educational entities, religious institutions, families, etc.) that utilize the services of mobile-device management system 106 as an MDM for their respective mobile-device management.

Third-party service providers 108 can include, inter alia, various cloud-computing platform providers, CRM providers, cellular/telephone network systems (e.g. a company that provides local, long distance or value-added services, etc.), and the like.

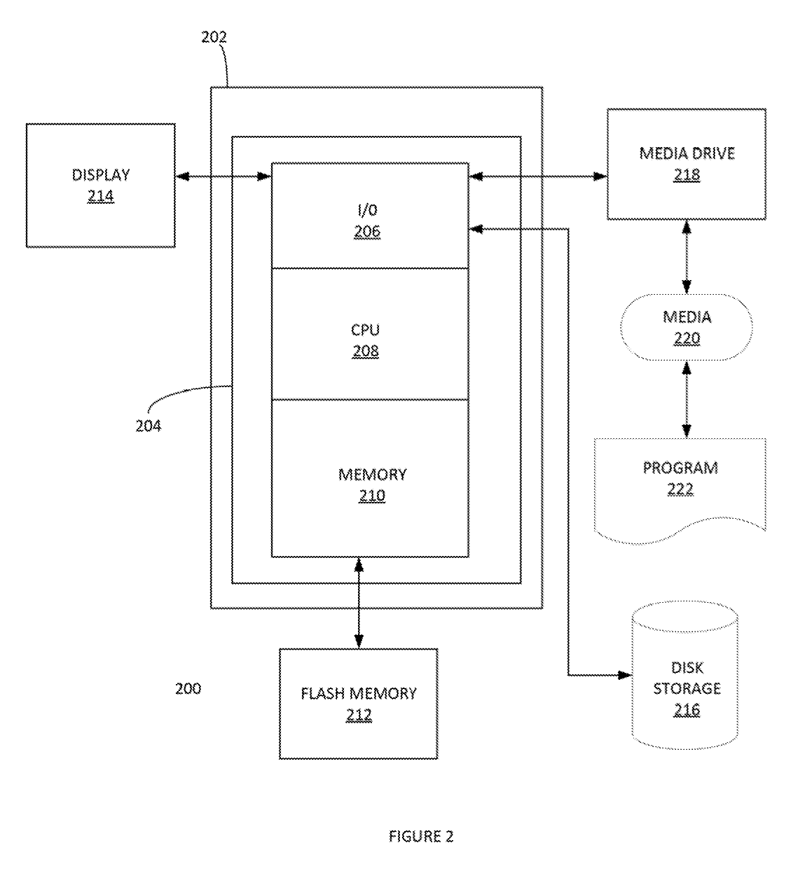

FIG. 2 depicts an exemplary computing system 200 that can be configured to perform any one of the processes provided herein. In this context, computing system 200 may include, for example, a processor, memory, storage, and I/O devices (e.g., monitor, keyboard, disk drive, Internet connection, etc.). However, computing system 200 may include circuitry or other specialized hardware for carrying out some or all aspects of the processes. In some operational settings, computing system 200 may be configured as a system that includes one or more units, each of which is configured to carry out some aspects of the processes either in software, hardware, or some combination thereof.

FIG. 2 depicts computing system 200 with a number of components that may be used to perform any of the processes described herein. The main system 202 includes a motherboard 204 having an I/O section 206, one or more central processing units (CPU) 208, and a memory section 210, which may have a flash memory card 212 related to it. The I/O section 206 can be connected to a display 214, a keyboard and/or other user input (not shown), a disk storage unit 216, and a media drive unit 218. The media drive unit 218 can read/write a computer-readable medium 220, which can contain programs 222 and/or data. Computing system 200 can include a web browser. Moreover, it is noted that computing system 200 can be configured to include additional systems in order to fulfill various functionalities. Computing system 200 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

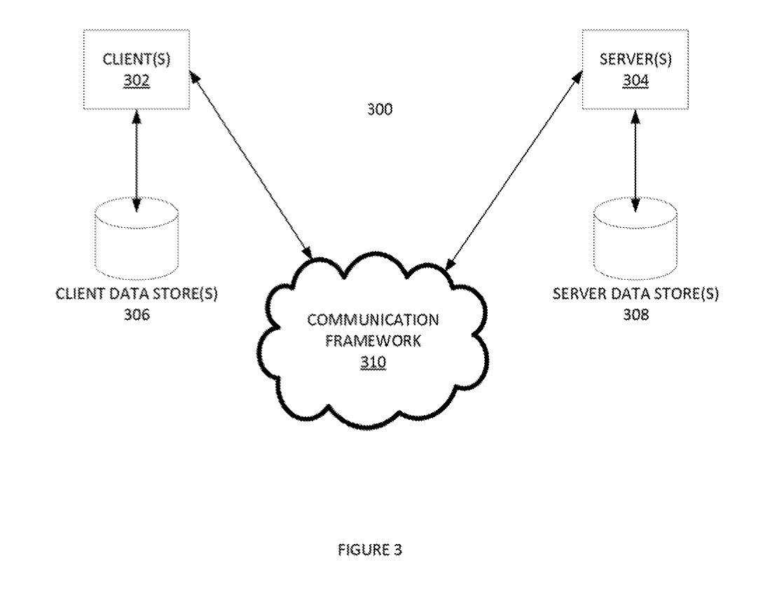

FIG. 3 is a block diagram of a sample computing environment 300 that can be utilized to implement various embodiments. The system 300 further illustrates a system that includes one or more client(s) 302. The client(s) 302 can be hardware and/or software (e.g., threads, processes, computing devices). The system 300 also includes one or more server(s) 304. The server(s) 304 can also be hardware and/or software (e.g., threads, processes, computing devices). One possible communication between a client 302 and a server 304 may be in the form of a data packet adapted to be transmitted between two or more computer processes. The system 300 includes a communication framework 310 that can be employed to facilitate communications between the client(s) 302 and the server(s) 304. The client(s) 302 are connected to one or more client data store(s) 306 that can be employed to store information local to the client(s) 302. Similarly, the server(s) 304 are connected to one or more server data store(s) 308 that can be employed to store information local to the server(s) 304. In some embodiments, system 300 can instead be a collection of remote computing services constituting a cloud-computing platform.

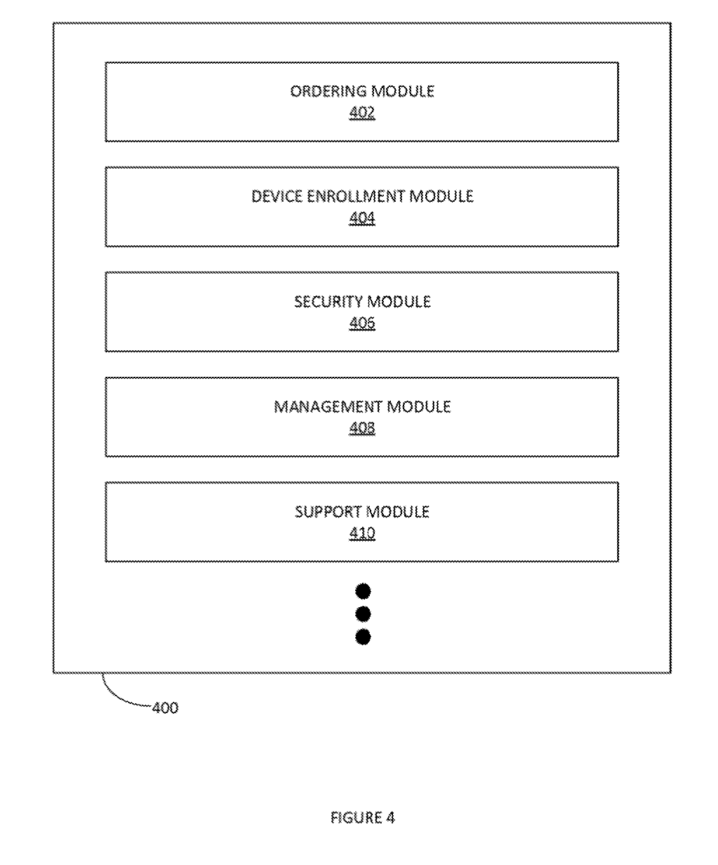

FIG. 4 illustrates an example Enterprise mobile managed services platform (EMMSP) 400 for implementing an integrated B2B digital mobile customer experience, according to some embodiments. Enterprise mobile managed services platform (EMMSP) 400 can be integrated into systems 100-300 supra. Enterprise mobile-device management system 400 can integrate and manage multiple MDM systems. Enterprise mobile-device management system 400 can remotely access and control mobile devices. Enterprise mobile-device management system 400 can manage mobile device functionalities. Enterprise mobile-device management system 400 can manage mobile device registration.

Ordering module 402 can interact with a customer at ordering stage of a mobile device. Ordering module 402 can trigger security and device enrollment. Ordering module 402 can manage various API micro services (e.g. utilizing a Java-based architecture that allows continuous integration of new services). Ordering module 402 can make the ordering experience simple and efficient for B2B customer. Ordering module 402 can implement profile-based ordering enabling a service provider to add a custom catalogue of their products and then an enterprise administrator within an enterprise can define product eligibility (e.g. which users within an enterprise have various permissions such as ordering various mobile devices based on organization hierarchy). Ordering module 402 can manage administrative workflows so that approvals can be obtained before orders are released by the enterprise to the service provider. Ordering module 402 can manage ordering IOT connectivity plans as well. Ordering module 402 can implement process 500 infra.

Ordering module 402 can enable telecom/cellular network service providers to allocate technology funds and/or hardware funds to enterprise customers as a loyalty bonus (e.g. based on the terms of the agreement, etc.) Ordering module 402 can automate this process. This can be done at the time of inception of an order itself and achieves workflow simplification. In this way, multiple entries in multiple systems can be avoided along with various coordination issues. For example, a complex area such as ‘return process’ for faulty goods can be automated and streamlined. Ordering module 402 can integrate into multiple warehousing systems of internal as well as well third-party contract logistics providers such as Brightstar®. Ordering module 402 can extract data flows form these systems securely and displays in order to simplify customer experience for enterprise customers and service providers.

Device enrollment module 404 can implement mobile-device enrollment. Device enrollment module 404 can be used to for mobile-device enrolment services for enterprise customers. Device enrollment module 404 store pre-enroll settings specific to an enterprise customer such that when an individual user within the enterprise receives the mobile device from a service provider, the mobile device is already pre-configured with settings specific to the enterprise. In this way, Device enrollment module 404 can decrease a setup time and alleviate the users to contact the enterprises IT departments for set up assistance. This system is connected to variety of vendors device enrolment services (Including but not limited to Apple, Google, Samsung, Microsoft) providing a common user interface and workflow to within the overall Enterprise mobile managed services platform (EMMSP)

Security module 406 can implement multi-layer mobile security protocols. In a first layer, security module 406 can assistant enterprise manage security of a mobile device by enforcing policies set by the enterprise. Security module 406 remotely track/disconnect/wipe mobile devices when a potential vulnerability is identified. Security module 406 can manage mobile-device registration (e.g. via a mobile-device management console. Security module 406 can periodically scan covered mobile devices for viruses and/or other vulnerabilities. Security module 406 can quarantine suspected mobile devices for inspection and/or elimination. Security module 406 can utilize various network-based security vendors, run security operations at the mobile-network level (e.g. Implemented at the service provider end) and/or identify threats to individual devices and isolate potential viruses, etc.

Security module 406 can links the solutions discussed supra together such that it is able to, inter alia: identify threats, take action through mobile device management (MDM) system 400 in a very unique way (e.g. using management module 408 infra). It is noted that system 100 can utilize a system architecture that enables an enterprise to use a mix of vendor platforms, extracting and simplifying through common interface (e.g. a single dashboard functionality, etc.). The integration providing with respect to ordering and/or enrolment services (e.g. per ordering module 402, etc.) can be utilized by Security module 406. Security module 406 can provide and manage a security dashboard that provides summary and/or status derived from multiple security technology. Security module 406 can provide an API that links any security alerts and dashboard needs to be integrated to overall security and/or incident management systems of an enterprise. Security module 406 can allow the addition of new security vendors in each of the various relevant domains. Security module 406 can cover IoT services and/or systems.

Management module 408 can incorporate multiple vendor MDMs within an enterprise or service provider environment. Management module 408 can implement various hybrid solutions where part of the solution is hosted internally as a dedicated (e.g. on-premises) instance and part of the solution is hosted in a cloud-computing platform. Management module 408 can provide MDM type solutions that can be deployed within an enterprise and managed service provider environments. Management module 408 can provide a common UI (e.g. dashboard) and reporting and management environment across all relevant MDMs. Management module 408 can implement and manage a meta-MDM management that can include both mobile device systems and IoT systems. Management module 408 can implement MDM analytics, report said analytics via the dashboard. These analytics can be used to support other modules. In this way, management module 408 can consolidate the management operations of the other module for a single unified presentation. Management module 408 can maintain asset registers. Asset registers can record assets purchased not only through an ordering module but also through other linked third-party hardware suppliers are presented in a consolidated way enabling customers to manage the fleets effectively. Management module 408 can be used to manage billing and other accounting operations related to MDM. Management module 408 can extract and consolidate data from other sources for presentation.

Support module 410 can implement a ticketing system integrated to a customer service software environment that enables the logging of faults and questions by customers, administrators, and the like. Support module 410 can integrate to service cloud (e.g. a Salesforce® service cloud, Zendesk etc.) and/or other support systems. Support module 410 can implement a customer relationship management (CRM) system. Support module 410 can provide B2B user journey of “order, enroll, secure, manage & support” that is unique.

Enterprise mobile managed services platform (EMMSP) 400 can include other systems not shown, such as, inter alia: database management systems, web servers, computer system security services, load balancers, firewall systems, virus detection systems, billing services, search engines, etc.

Example Methods and Processes

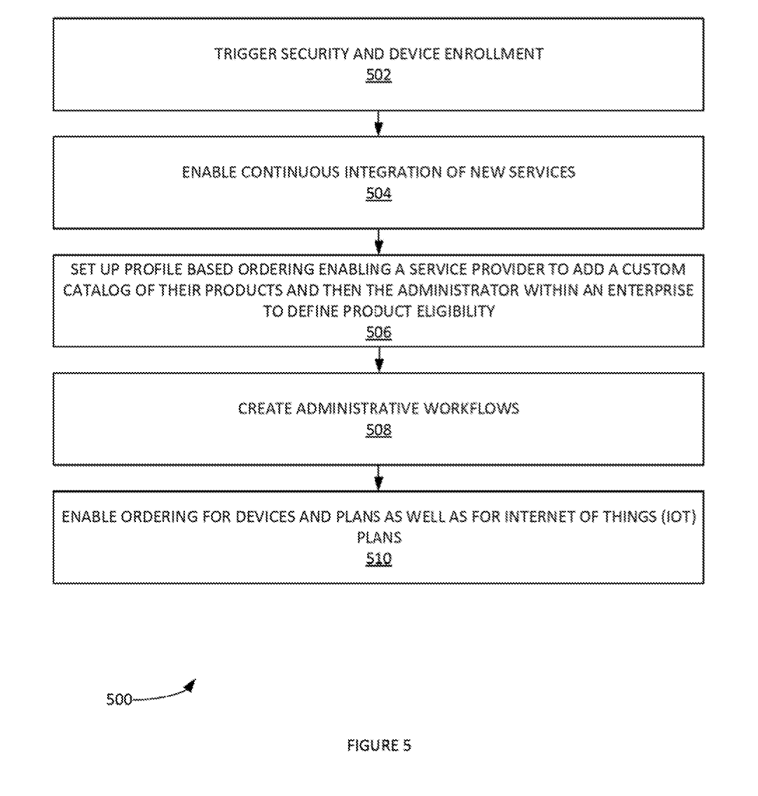

FIG. 5 illustrates an example process 500 for providing a single integrated experience B2B digital mobile customer, according to some embodiments. In step 502, process 500 can trigger security and mobile device enrollment. For example, a customer can, at an ordering stage, trigger security and mobile device enrolment. It is noted that security can be offered by various third party mobile device management providers (e.g. Airwatch®, SOTI®, Microsoft inTune®, Nokia® network security and/or mobile device enrolment via Apple®, Samsung®, Google®, etc. Process 500 can provide and manage a set of API micro services that utilizes a Java architecture that allows continuous integration of new services. After step 502, process 500 can continue to integrate various standalone solutions into its system in order to make the experience simple and efficient for B2B customer.

In step 504, process 500 can enable continuous integration of new services. In step 506, process 500 can set up profile-based ordering enabling a service provider to add a custom catalog of their products and then the administrator within an enterprise to define product eligibility.

In step 508, process 500 can create administrative workflows. This can so that approvals can be obtained before orders are released by the enterprise to the service provider.

In step 510, process 500 can enable ordering for mobile devices and plans as well as for internet of things (IOT) connectivity plans. For example, ordering can be, not only for mobile devices and plans, but also for IOT plans that utilize a different fulfillment model through integration with IOT platforms such as Jasper*, etc. using a flexible and open architecture. Ordering also includes multiparty delivery orchestration of a devices (for example, a device can be supplied by one party, configured by another party, security certified by another party, loaded and tested with another software and delivered to end user as integrated solution) Ordering system will coordinate between multiple parties to provide a seamless experience to end user.

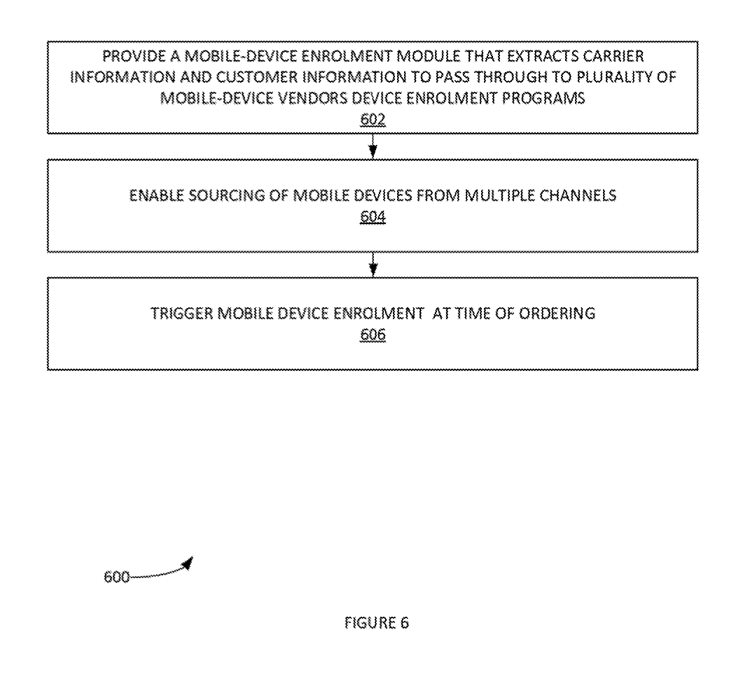

FIG. 6 illustrates an example process 600 for implementing mobile-device enrollment, according to some embodiments. Process 600 can be used to for mobile-device enrolment services for enterprise customers. Process 600 can store pre-enroll settings specific to an enterprise customer such that when an individual user within the enterprise receives the mobile device from a service provider, the mobile device is already pre-configured with settings specific to the enterprise. In this way, process 600 can decrease a setup time and alleviate the time for users to contact various enterprise IT departments for set up assistance.

More specifically, in step 602, process 600 can provide a mobile-device enrolment module that extracts carrier information and customer information to pass through to plurality of mobile-device vendors mobile device enrolment programs. For example, the mobile-device enrolment module that is capable of extracting carrier information, customer information including relevant security credentials to pass through to various handset vendors mobile device enrolment programs. Step 602 can provide a common framework across multiple programs and simplify the process for service providers and enterprise customers.

In step 604, process 600 can enable sourcing of mobile devices from multiple channels (e.g. a mix of telecom dealers, hardware vendors in addition to the telecommunication service provider). In step 606, process 600 can trigger mobile device enrolment at time of ordering. Process 600 can be implemented with an open module architecture capable of integrating with different environments and/or also extendable to include other new hardware vendor programs.

### ADDITIONAL EMBODIMENTS

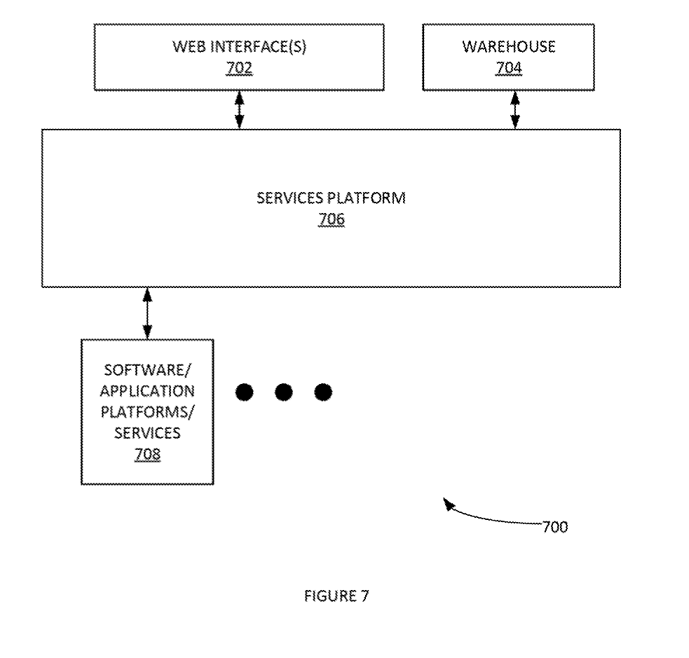

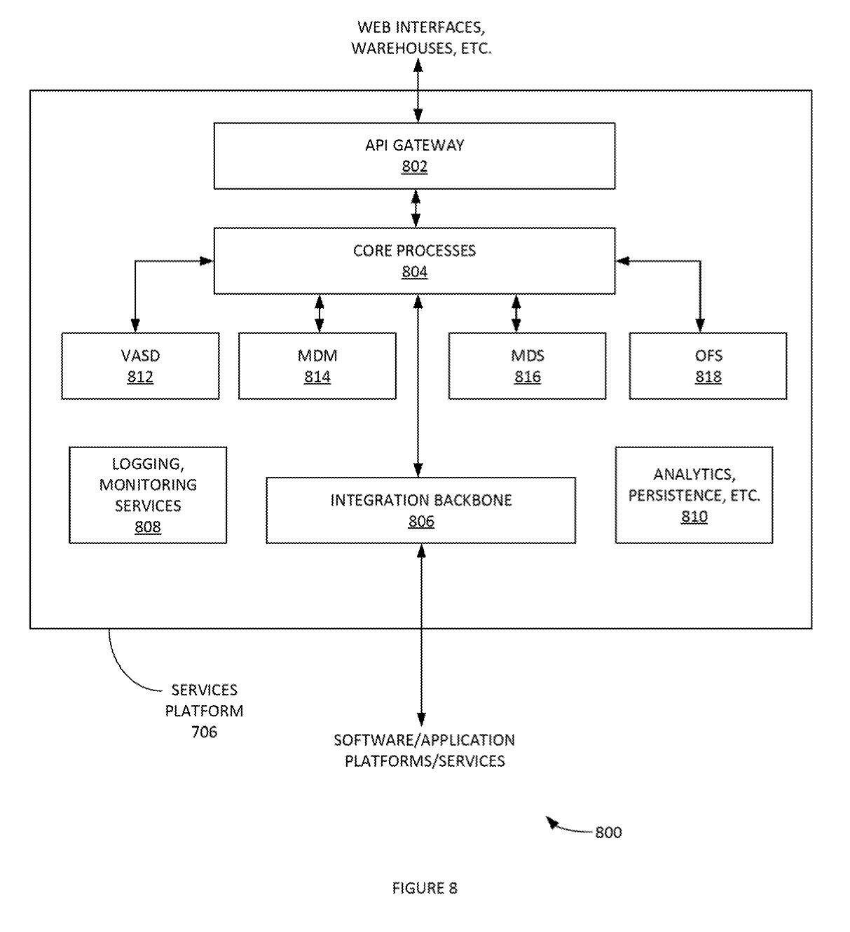

FIG. 7 illustrates another example system 700 for implementing an integrated B2B digital mobile customer experience, according to some embodiments. System 700 can provide an end-to-end platform to streamline procurement, deployment, security and management of Enterprise mobile and IOT fleets. System 700 can provide a solution that is deployable directly by larger enterprises with dedicated IT departments. System 700 can include a service platform 706. Service platform 706 can generally manage the integrated B2B digital mobile customer experience (e.g. see FIG. 8 infra). Web interfaces 702 can enable an enterprise to use a mix of vendor platforms, extracting and simplifying through common interface with a single dashboard functionality on a web page(s). Service platform 706 can interface with web interfaces 702 via an external API. Warehouse 704 can include a data warehouse used for reporting and data analysis for business intelligence. Service platform 706 can interface with warehouse 704 via a callback API. Service platform 706 can also manage security services, access to third-party applications and cloud-computing platform services, etc. Security services control what information is exposed outside the system using a security module within service platform 706.

Software application platforms/services 708 can include a variety of third-party applications and services. Example services can include, inter alia: fulfillment services, customer support services, application mobility management services, email service, other messaging services, a cloud-based software platform for the Internet of Things (IoT), etc.

FIG. 8 illustrates an example services platform 706, according to some embodiments. Services platform 706 can include an API gateway 802. API gateway 802 can a server that act as an API front-end, receives API requests, enforces throttling and security policies, passes requests to the back-end service and then passes the response back to the requester. API gateway can include a transformation engine to orchestrate and modify the requests and responses on the fly. API gateway 802 can also provide functionality such collecting analytics data and providing caching. API gateway 802 can provide functionality to support authentication, authorization, security, audit and regulatory compliance.

Core process 804 can manage the core logic and data persistence. Core process 804 can provide communication with the internal services provided by services platform 706 via internal API(s).

Value added services for devices (VASD) 812 can manage non-core services (e.g. services beyond standard voice calls and the like).

Mobile device management services (MDMS) 814 can implement a B2B digital mobile customer experience including, inter alia: Meta MDM managing multiple device management solutions with multiple enterprises or multiple MDMs within an enterprise In this way, a customer can manage all the various mobile services through a single set of interfaces.

Device enrollment services (MDS) 816 can automate and manage the enrollment for mobile devices so that, when activated, the mobile device is configured with various account settings, application, relevant corporate services, etc. This can be automated for enterprise customers. For example, MDS 816 can store pre-enroll settings specific to an enterprise customer such that when an individual user within the enterprise receives the mobile device from a service provider, the mobile device is already pre-configured with settings specific to the enterprise. In this way, services platform 706 can decrease a setup time and alleviate the users to contact the enterprises IT departments for set up assistance. Order fulfillment servers (OFS) 818 can automate and manage the fulfillment of client orders.

Integration backbone 806 can manage all security and tenant management of external systems. includes tokes, certificates, etc. Module 808 can manage logging processes and monitoring services. Module 810 can manage analytics, persistence services, data warehousing, data reporting, etc.

In one example, services platform 706 exposes a single API for a customer-side computing system to interact with to manage the various services provide by and/or through services platform 706.

### CONCLUSION

Although the present embodiments have been described with reference to specific example embodiments, various modifications and changes can be made to these embodiments without departing from the broader spirit and scope of the various embodiments. For example, the various mobile devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an Illustrative rather than a restrictive sense. In some embodiments, the machine-readable medium can be a non-transitory form of machine-readable medium.

What is claimed:

1. A computerized method useful for implementing an integrated B2B digital mobile customer experience comprising:
at a mobile device ordering stage, triggering a mobile device enrollment for a mobile device owned by a customer enterprise;
managing a set of application programming interface (API) micro services that enables a continuous integration of mobile device services for the mobile device;
setting up a mobile device profile-based ordering system that enables a mobile-device service provider to:
add a custom catalog of mobile-devices service products for the customer enterprise; and
enable an administrator within the customer enterprise to define a product eligibility for the mobile device; and
generating a set of administrative workflows that provide an approval of the mobile-devices service product before an order for the mobile-devices service product is released by the enterprise to the service provider.

2. The computerized method of claim 1 further comprising:
at a mobile device ordering stage, triggering a security protocol enrollment for the mobile device, and wherein a security protocol is provided by a third party mobile device management provider.

3. The computerized method of claim 2, wherein the mobile device comprises an internet of things (IOT) device.

4. The computerized method of claim 3, wherein the custom catalog of mobile-devices service products for the customer enterprise further comprises an IOT device plan and IOT service products.

5. The computerized method of claim 1 further comprising:
extracting a mobile-device carrier information and a customer enterprise information to pass through to plurality of mobile-device vendors mobile device enrolment programs.

6. The computerized method of claim 2 further comprising:
enabling a sourcing of the mobile device from a plurality of channels, wherein a channel comprises a mix of a telecom dealer, a hardware vendor and a telecommunication service provider.

7. The computerized method of claim 6 further comprising:
triggering the mobile device enrolment at a time of ordering the mobile device by the customer enterprise.

8. The computerized method of claim 7 further comprising:
providing an open module architecture integrates with different mobile-device environments, and wherein the open module architecture is extendable to include other mobile-device hardware vendor programs.

9. A computerized system useful for implementing an integrated B2B digital mobile customer experience comprising:
at least one processor configured to execute instructions;
a memory containing instructions when executed on the processor, causes the at least one processor to perform operations that:
at a mobile device ordering stage, automatically trigger a mobile device enrollment for a mobile device owned by a customer enterprise;
manage a set of application programming interface (API) micro services that enables a continuous integration of mobile device services for the mobile device;
set up a mobile device profile-based ordering system that enables a mobile-device service provider to:
add a custom catalog of mobile-devices service products for the customer enterprise; and
enable an administrator within the customer enterprise to define a product eligibility for the mobile device; and
generate a set of administrative workflows that provides an approval of the mobile-devices service product before an order for the mobile-devices service product is released by the enterprise to the service provider.

10. The computerized system of claim 9, wherein the memory contains instructions that when executed on the processor, causes the at least one processor to perform operations that:
at a mobile device ordering stage, triggers a security protocol enrollment for the mobile device, and wherein a security protocol is provided by a third party mobile device management provider.

11. The computerized method of claim 10, wherein the mobile device comprises an internet of things (IOT) device.

12. The computerized method of claim 11, wherein the custom catalog of mobile-devices service products for the customer enterprise further comprises an IOT device plan and IOT service products.

13. The computerized method of claim 12, wherein the memory contains instructions that when executed on the processor, causes the at least one processor to perform operations that:
extracts a mobile-device carrier information and a customer enterprise information to pass through to plurality of mobile-device vendors mobile device enrolment programs.

14. The computerized method of claim 13, wherein the memory contains Instructions that when executed on the processor, causes the at least one processor to perform operations that:
enables a sourcing of the mobile device from a plurality of channels, wherein a channel comprises a mix of a telecom dealer, a hardware vendor and a telecommunication service provider.

15. The computerized method of claim 15, wherein the memory contains instructions that when executed on the processor, causes the at least one processor to perform operations that:
triggers the mobile device enrolment at a time of ordering the mobile device by the customer enterprise.

16. The computerized method of claim 7 wherein the memory contains instructions that when executed on the processor, causes the at least one processor to perform operations that:
provides an open module architecture integrates with different mobile-device environments, and wherein the open module architecture is extendable to include other mobile-device hardware vendor programs.
